(19) United States
(12) Patent Application Publication
(10) Pub. No.: US 2007/0084038 A1
(43) Pub. Date: Apr. 19, 2007

(54) Riveting method

(76) Inventor: Patrick Cochet, Albens (FR)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/545,683

(22) Filed: Oct. 10, 2006

(30) Foreign Application Priority Data
Oct. 10, 2005 (FR) 05 10336

(51) Int. Cl. B23P 11/00; B21D 39/00

(52) U.S. Cl. 29/524.1; 29/505; 29/525.06

(57) ABSTRACT

The invention relates to a method of riveting a first element to a second element, comprising a preparation step during which the first element is applied in contact with the second element, and an insertion step during which a rivet (3) is entrained so as to pass through the two elements (1, 2).

According to the invention, the method comprises a presentation step between the preparation step and the insertion step, during which penetration surface (6) of the rivet (3) is brought into contact with a portion of the surface of a first element (1), the penetration surface (6) being shaped such that during the insertion step, the rivet (3) entrains the surface portion so as to trap a portion of volume (11) of the first element (1) between the rivet (3) and the second element (2).

This invention relates to a related method for riveting a gripping device onto the body of a kitchen utensil, for example a method of riveting a side handle or a top handle onto the body of a saucepan, frying pan, stewpot, etc.

One known method for riveting a gripping device on the body of a kitchen utensil of the type comprises a preparation step during which the gripping device is applied in contact with the body and an insertion step during which a rivet is driven so as to pass through the two elements. Furthermore, conventionally, once the rivet is in place, the end of the rivet having passed through the two elements is compressed so as to form the connection between the two elements.

The disadvantage of such a method is that it requires tolerances on the dimensions of the riveting holes of the two elements and the body of the rivet, and extreme dispersions that can create risks of discontinuity between the rivet and at least one of the riveting holes once the riveting is complete, which can cause leak tightness problems.

This invention is intended to overcome the above mentioned disadvantages, in other words to describe a riveting method capable of reducing tolerance requirements on the dimensions of riveting holes and the body of the rivet and to make the leak tightness of riveting more reliable.

According to the invention, the above mentioned type of riveting method comprises a presentation step between the preparation step and the insertion step, during which a rivet penetration surface is brought into contact with a portion of the surface of a first element, the penetration surface being confirmed such that during the insertion step, the rivet passes through the first element at a first riveting hole and entrains the surface portion so as to trap it between itself and a second riveting hole that is carried by the second element and into which the rivet fits.

Thus, according to the invention, the tolerance between the dimensions of the rivet body and the dimensions of the riveting hole carried by the second element are less restrictive, the play being sufficient to allow creep of a portion of the first element. Furthermore, due to creep and the resulting trapping, the trapped portion of the first element can improve the leak tightness of the riveted connection.

Other special features and advantages will become clear from the description of embodiments given as non-limitative examples and illustrated by the drawings among which:

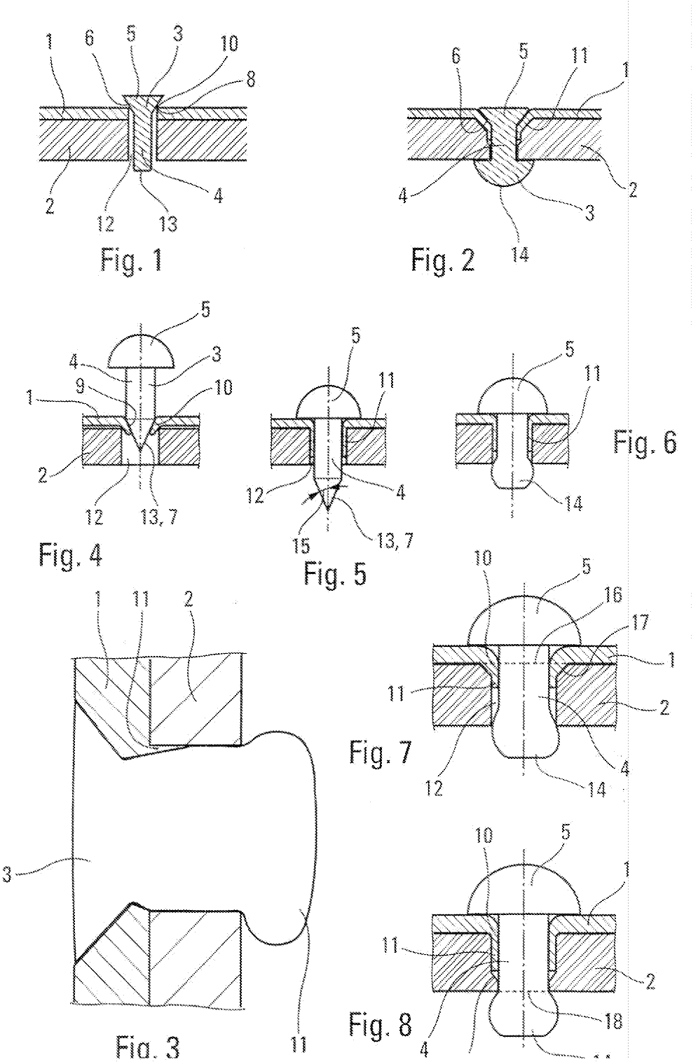

FIG. 1 is a diagrammatic sectional view through the rivet and two elements during the presentation step for a first embodiment of the method according to this invention.

FIG. 2 is a diagrammatic sectional view through the riveting obtained by the use of the first embodiment of the method,

FIG. 3 is a photographic reproduction of the riveting obtained by use of a second embodiment of the method,

FIG. 4 is a diagrammatic sectional view through the rivet and two elements during the insertion step for a third embodiment of the method.

FIG. 5 is a diagrammatic sectional view similar to FIG. 4 once the insertion step is complete,

FIG. 6 is a diagrammatic sectional view similar to FIGS. 4 and 5, representing the riveting obtained by the use of the third embodiment of the method.

FIG. 7 is a diagrammatic sectional view representing the riveting obtained by use of a fourth embodiment of the method, and

FIG. 8 is a diagrammatic sectional view showing the riveting obtained by the use of a fifth embodiment of the method.

As can be seen on the different figures, implementation of this invention requires the use of a first element 1 (for example the body of a kitchen utensil), a second element 2 (for example the gripping device of a kitchen utensil) and a rivet 3 (preferably made of stainless steel) that comprises a body 4 (the part that will pass through the two elements), a head 5 (the part that does not pass through the two elements) and a penetration surface 6, 7.

In a first preparation step, the two elements 1, 2 are applied in contact with each other correctly. In a second presentation step, the rivet 3 is then correctly positioned with respect to the two elements 1, 2, more precisely its penetration surface 6, 7 is made to stop in contact with a surface portion 8, 9 of the first element 1. After a third insertion step, the rivet 3 is driven (usually by striking its head 5) so as to pass through the two elements 1, 2. During this insertion step, due to confirmation of the penetration surface 6, 7 and its stopping in contact with the portion of surface 8, 9 of the first element 1, the rivet 3 entrains the surface portion 8, 9 with it as it passes through the first of this step is creep of a portion of volume 11 of the first element 1 that is trapped between the rivet 3 (more precisely the body 4 of the rivet 3) and the second element 2 (more precisely a second riveting hole 12 in the second element 2 in which the body 4 of the rivet 3 is located). Finally, in the last riveting step, the free end 13 of the body 4 of the rivet 3 is struck so as to form a trapping rim 14 (the rivet 3 being held in place by a part in contact with the head 5). Thus, according to the riveting method, the two parts 1, 2 are trapped by classical expansion of the rivet 3 and creep of the entrained portion of the volume 11 of the first element 1.

In general, the dimensions of the body 4 and the second riveting hole 12 must enable insertion of the material of the first element 1. Furthermore, the profile of the penetration surface 6, 7 and the profile of the portion of surface 8, 9 against which it stops in contact are shaped so as to facilitate entrainment of material from the first element 1 (there must be a certain angle between the two surfaces at their contact). Thus, the penetration surface 6, 7 may for example advantageously have a conical, ogival or prismatic shape. Similarly, the cross-section of the penetration surface, 6 7 may be circular, square or for example cross shaped. In the case of a conical surface, it is advantageous that the half-angel at the summit 15 is about 50°. The creep qualities also depend on the hardness of the rivet 3 compared with the hardnesses of the two elements 1, 2, the dimensions of each of the riveting holes 10, 12 and the thickness of the first element 1.

Preferably, the creep should be such that the penetration height of the first element 1 in the second element 2 is greater than a quarter of the height of the second riveting hole 12, so as to obtain a good trapping effect of the first element 1 between the rivet 3 and the second element 2.

In the two first embodiments as illustrated in FIGS. 1 to 3, each of the two elements 1, 2 has its riveting hole 10, 12 prior to the preparation step. As can be seen in FIG. 1, in the presentation step, the two riveting holes 10, 12 are arranged so that they are in line with each other, the body 4 of the rivet 3 is inserted into the two holes 10, 12 and the penetration surface 6 formed by the collar 6 of the rivet 3 connecting the head 5 to the body 4 stops in contact with the periphery 8 of the first riveting hole 10 (that is the same size as or is smaller than the second riveting hole 12). Such embodiments can result in riveting in which the head 5 of the rivet 3 is flush with the surface of the first element 1, without the need to form a chamfer in the first element 1 acting as a housing for the head 5: during the insertion step, entrainment of the portion of volume 11 by the collar 6 causes flattening of at least one of the two elements 1, 2 under the head 5 (depending on the stiffness of these elements 1, 2).

FIG. 2 illustrates the riveting obtained when the first element 1 is stiffer (typically made of stainless steel for example with a yield stress of 270 MPa) than the second element 2 (typically made of aluminum for example with a yield stress of 70 MPa). In this case, the second element 2 is deformed due to the pressure applied to the rivet 3 and transmitted through the first element 2.

FIG. 3 shows the riveting obtained when the second element 2 is stiffer (for example made of stainless steel) than the first element 1 (for example made of aluminum). In this case, only the first element 1 is deformed due to the pressure applied on the rivet 3.

In the other three embodiments illustrated in FIGS. 4 to 8, the riveting hole 12 is formed in the second element 2 facing the first element 1, before the preparation step. During the preparation step, the first solid element 1 (in other words without a hole) is brought into contact with the second element 2 and covers the second riveting hole 12. During the presentation step, the free end 13 of the body 4 of the rivet 3 that forms the penetration surface 7 is in contact with the portion of the surface 9 of the first element 1 covering the second riveting hole 12. As can be seen on FIG. 4, during the insertion step, the penetration surface 7 penetrates into the first element 1 and thus makes the first riveting hole 10. Furthermore, the second riveting hole 12 is used as a rivet guide 3. Such embodiments has the advantage of eliminating a prior step for drilling the first element.

In FIG. 7, the second riveting hole 12 has a chamfer 17 at its input 16 oriented so as to reduce the diameter of the hole 12 for displacement in the direction of the rivet 3. This chamfer 17 facilitates creep of the first element 1.

In FIG. 8, the second riveting hole 12 has a chamfer 19 at its output 18 oriented in the direction to reduce the diameter of the hole 12 for a displacement in the direction of the rivet 3. This chamfer 19 can contain a relatively large volume 11 of the first element 1 (large part of the second riveting hole 12), so that expansion of the rivet 3 itself provides a good seal (narrow part of the second riveting hole 12).

Other embodiments of this invention are possible. It will thus be possible for the first element to be the gripping device for a kitchen utensil and the second element could be the body of the utensil. It would also be possible to make the second riveting hole at the same time as the first riveting hole during the insertion step of the rivet body through the free end.

1. A method for riveting a gripping device on the body of a kitchen utensil comprising: a preparation step where the gripping device is applied in contact with the body, and in insertion step wherein a rivet (3) is driven so as to pass through the two elements (1, 2), characterised in that it comprises a presentation step between the penetration step and the insertion step, during which a penetration surface (6, 7) of the rivet (3) is brought into contact with a portion of the surface (8, 9) of a first element (1), the penetration surface (6, 7) being shaped such that during the insertion step, the rivet (3) passes through the first element (1) at a first riveting hole (10) and entrains the surface portion (8, 9) so as to trap a portion of volume (11) of the first element (1) between the rivet (3) and a second riveting hole (12) that is carried by the second element (2) and into which the rivet fits (3).

2. The riveting method according to claim 1, wherein the second riveting hole (12) is made by the preparation step and is used as a rivet guide (3) during the insertion step.

3. The riveting method according to claim 1, wherein the second riveting hole (12) is made before the preparation step and is used as a rivet guide (3) during the insertion step.

4. The riveting method according to claim 1, wherein the first riveting hole (10) is made during the insertion step by the penetration surface (7) that is formed by the free end (13) of the body (4) of the rivet (3).

5. The riveting method according to claim 3, wherein the first riveting hole (10) is made before the preparation step and is arranged in line with the second riveting hole (12) during the preparation step, the penetration surface (6) formed by the collar (6) of the rivet connecting the head (5) to the body (4) being stopped during the presentation step in contact with the periphery (8) of the first riveting hole (10).

6. The riveting method according to claim 5, characterised in that during the insertion step, entrainment of the portion of volume (11) by the collar (6) causes flattening of at least one to the two elements (1, 2) under the head (5) so that at the end of this step, the head (5) is flush with the surface of the first element (1).

7. The riveting method according to claim 4 wherein the second riveting hole (12) has a chamfer (17, 19) oriented so as to reduce the diameter of the hole (12) for a displacement in the direction of the rivet (3).

8. The riveting method according to claim 7 wherein the chamfer (17) is made close to the entry (16) to the second riveting hole (12).

9. The riveting method according to claim 17, wherein the chamfer (19) is made close to the exit (18) from the second riveting hole (12).

10. The riveting method according to claim 1, wherein the penetration surface (6, 7) has a shape selected from the group consisting of conical, ogival or prismatic.

11. The riveting method according to claim 2, wherein the first riveting hole (10) is made during the insertion step by the penetration surface (7) that is formed by the free end (13) of the body (4) of the rivet (3).

12. The riveting method according to claim 3, wherein the first riveting hole (10) is made during the insertion step by the penetration surface (7) that is formed by the free end (13) of the body (4) of the rivet (3).

13. The riveting method according to claim 5, wherein the second riveting hole (12) has a chamfer (17, 19) oriented so as to reduce the diameter of the hole (12) for a displacement in the direction of the rivet (3).

14. The riveting method according to claim 6, wherein the second riveting hole (12) has a chamfer (17, 19) oriented so as to reduce the diameter of the hole (12) for a displacement in the direction of the rivet (3).

15. The riveting method according to claim 6, wherein the penetration surface (6, 7) has a shape selected from the group consisting of conical, ogival and prismatic.

16. The riveting method according to claim 9, wherein the penetration surface (6, 7) has a shape selected from the group consisting of conical ogival and prismatic.

17. The riveting method according to claim 11, wherein the penetration surface (6, 7) has a shape selected from the group consisting of conical ogival and prismatic.
